(19) United States
(12) Patent Application Publication
(10) Pub. No.: US 2014/0348189 A1
(43) Pub. Date: Nov. 27, 2014

(54) LASER APPARATUS

(71) Applicant: GIGAPHOTON INC., Tochigi-ken (JP)

(72) Inventors: Krzysztof NOWAK, Tochigi-ken (JP); Osamu Wakabayashi, Tochigi-ken (JP)

(73) Assignee: GIGAPHOTON INC.

(21) Appl. No.: 14/455,576

(22) Filed: Aug. 8, 2014

Related U.S. Application Data
(63) Continuation of application No. PCT/IB2012/002758, filed on Dec. 19, 2012.

(30) Foreign Application Priority Data
Mar. 27, 2012 (JP) 2012-072585

(51) Int. Cl. H01S 3/00; H05G 2/00

(52) U.S. Cl. CPC H01S 3/005; H05G 2/008
USPC 372/25

(57) ABSTRACT

A laser apparatus may include a master oscillator configured to output a laser beam, at least one amplifier provided in a beam path of the laser beam, at least one saturable absorber gas cell provided downstream from the at least one amplifier and configured to contain a saturable absorber gas for absorbing a part of the laser beam, the part having a beam intensity equal to or lower than a predetermined beam intensity, and a cooling unit for cooling the saturable absorber gas.

### CROSS-REFERENCE TO RELATED APPLICATION

The present application claims priority from Japanese Patent Application No. 2012-072585 filed Mar. 27, 2012.

### BACKGROUND

1. Technical Field

The present disclosure relates to laser apparatuses.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 μm to 45 μm, and further, microfabrication with feature sizes of 32 μm or less will be required. In order to meet the demand for microfabrication with feature sizes of 32 μm or less, for example, an exposure apparatus is needed which combines a system for generating EUV light at a wavelength of approximately 13 μm with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A laser apparatus according to one aspect of the present disclosure may include a master oscillator configured to output a laser beam, at least one amplifier provided in a beam path of the laser beam, at least one saturable absorber gas cell provided downstream from the at least one amplifier and configured to contain a saturable absorber gas for absorbing a part of the laser beam, the part having beam intensity equal to or lower than predetermined beam intensity, and a cooling unit for cooling the saturable absorber gas.

### BRIEF DESCRIPTION OF THE DRAWINGS

Hereinafter, selected embodiments of the present disclosure will be described with reference to the accompanying drawings.

FIG. 1 schematically illustrates a configuration of an exemplary LPP type EUV light generation system.

FIG. 2 illustrates an example of a laser apparatus according to one embodiment of the present disclosure.

FIG. 3 illustrates an example of optical transmission properties of a saturable absorber gas.

FIG. 4A illustrates an example of beam intensity of a laser beam prior to passing through a saturable absorber gas cell.

FIG. 4B illustrates an example of beam intensity of a laser beam after passing through a saturable absorber gas cell.

FIG. 5A is a sectional view of a saturable absorber gas cell in a laser apparatus according to one embodiment of the present disclosure.

FIG. 5B is a sectional view of the saturable absorber gas cell shown in FIG. 5A, taken along VB-VB plane.

FIG. 6A is a sectional view illustrating an example of a saturable absorber gas cell according to a first modification.

FIG. 6B is a sectional view of the saturable absorber gas cell shown in FIG. 6A, taken along VIB-VIB plane.

FIG. 7 illustrates an example of a saturable absorber gas cell system in a laser apparatus according to one embodiment of the present disclosure.

FIG. 8 illustrates an example of a slab amplifier in a laser apparatus according to one embodiment of the present disclosure.

FIG. 9 illustrates an example of a saturable absorber gas cell according to a second modification.

FIG. 10 illustrates an example of a saturable absorber gas cell according to a third modification.

### DETAILED DESCRIPTION

Embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein. Hereinafter, selected embodiments of the present disclosure will be described in detail with reference to the accompanying drawings. The embodiments of the present disclosure will be described following the table of contents below.

### Contents

### 1. Overview of EUV Light Generation System

### 1.1 Configuration

### 1.2 Operation

### 2. Terms

### 2. Laser Apparatus Including Optical Isolator

### 2.1 Configuration

### 2.2 Operation

### 2.3 Effect

### 3. Slab Saturable Absorber Gas Cell

### 3.1 Configuration

### 3.2 Operation

### 3.3 Effect

### 3.4 Multipass Saturable Absorber Gas Cell

### 3.5 Saturable Absorber Gas Cell System

4. Combining with Slab Amplifier

### 5. External Cooling System Saturable Absorber Gas Cell

### 5.1 Plate Type External Cooling System Saturable Absorber Gas Cell

### 5.2 Jacket Type External Cooling System Saturable Absorber Gas Cell

### 1. Overview of EUV Light Generation System

### 1.1 Configuration

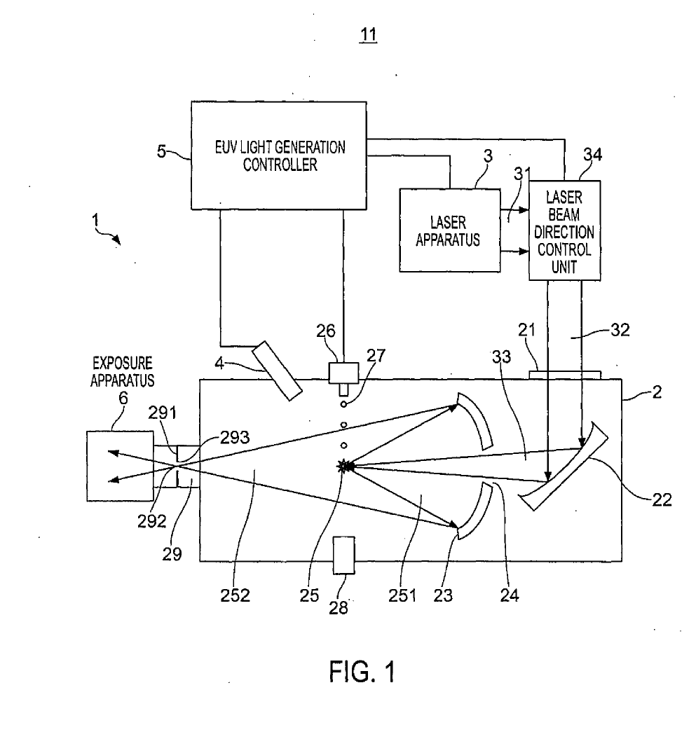

FIG. 1 schematically illustrates an exemplary configuration of an LPP type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may, for example, be provided in the chamber 2. The EUV collector mirror 23 may have a multi-layered reflective film formed on the spheroidal surface thereof. The reflective film may include a molybdenum layer and a silicon layer, which are alternately laminated. The EUV collector mirror 23 may have a first focus and a second focus, and may be positioned such that the first focus lies in a plasma generation region 25 and the second focus lies in an intermediate focus (IF) region 292 defined by the specifications of an external apparatus, such as an exposure apparatus 6. The EUV collector mirror 23 may have a through-hole 24 formed at the center thereof so that a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, trajectory, position, and speed of a target 27.

Further, the EUV light generation system 11 may include a connection part 29 for allowing the interior of the chamber 2 to be in communication with the interior of the exposure apparatus 6. A wall 291 having an aperture 293 may be provided in the connection part 29. The wall 291 may be positioned such that the second focus of the EUV collector mirror 23 lies in the aperture 293 formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation or posture of the optical element.

### 1.2 Operation

With continued reference to FIG. 1, a pulse laser beam 31 outputted from the laser apparatus 3 may pass through the laser beam direction control unit 34 and be outputted therefrom as the pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted and the direction into which the target 27 is outputted. Furthermore, the EUV light generation controller 5 may be configured to control at least one of: the timing when the laser apparatus 3 oscillates, the direction in which the pulse laser beam 33 travels, and the position at which the pulse laser beam 33 is focused. It will be appreciated that the various controls mentioned above are merely examples, and other controls may be added as necessary.

### 2. Laser Apparatus Including Optical Isolator

### 2.1 Configuration

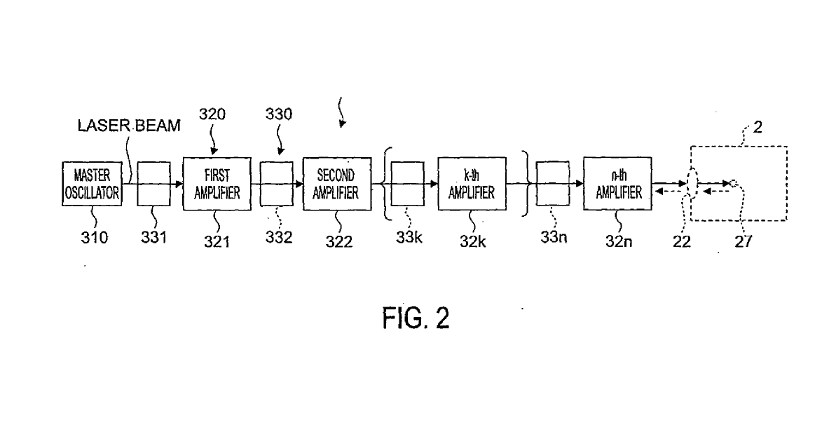

FIG. 2 illustrates an example of a laser apparatus according to one embodiment of the present disclosure. In FIG. 2, a laser apparatus 3 may include a master oscillator 310, at least one amplifier 320, and at least one optical isolator 330. The at least one amplifier 320 may include a plurality of amplifiers 321 through 32n. In FIG. 2, a first amplifier 321, a second amplifier 322, a k-th amplifier 32k, and an n-th amplifier 32n are illustrated. Similarly, the at least one optical isolator 330 may include a plurality of optical isolators 331 through 33n. In FIG. 2, a first optical isolator 331, a second optical isolator 332, a k-th optical isolator 33k, and an n-th optical isolator 33n are illustrated. Hereinafter, the reference numeral “320” may be used to collectively designate the amplifiers 321 through 32n. Similarly, the reference numeral “330” may be used to collectively designate the optical isolators 331 through 33n. Further, in FIG. 2, a chamber 2, a target 27, and a laser beam focusing optical system 22 described with reference to FIG. 1 are also illustrated as related constituent elements.

The amplifiers 320 and the optical isolators 330 may be provided in a beam path of a laser beam outputted from the master oscillator 310. The first optical isolator 331 may be provided downstream from the master oscillator 310. The second through n-th optical isolators 332 through 33n may be provided downstream from the amplifiers 321 through 32k, respectively. That is, the first optical isolator 331 may be provided between the master oscillator 310 and the first amplifier 321. Each of the second through n-th optical isolators 332 through 33n may be provided between the amplifiers 32k−1 and 32k. Here, k is a given natural number between 2 and n.

The master oscillator 310 may oscillate to output a laser beam in pulses at a predetermined repetition rate. The master oscillator 310 may be configured of any laser devices suitable for applications, and may, for example, be a laser device configured to oscillate in a bandwidth of a CO₂ laser medium.

An amplifier 320 may be provided to amplify the laser beam. Any suitable amplifiers 320 may be used as the amplifier 320 depending on the applications. In this embodiment, for example, an amplifier 320 containing CO₂ gas as a gain medium may be used.

An optical isolator 330 may be provided to suppress a backpropagating beam from a target 27 and/or self-oscillation of an amplifier 320. In the laser apparatus 3 shown in FIG. 2, a saturable absorber gas cell may be used as at least one or more of the second through n-th optical isolators 332 through 33n provided downstream from the amplifiers 321 through 32k, respectively. Here, a saturable absorber gas cell or another type of optical isolator may be used as the first optical isolator 331. For example, an electro-optical (EO) Pockels cell in which an EO crystal formed of CdTe is held between electrodes and which functions as an optical isolator may be used as the first optical isolator 331.

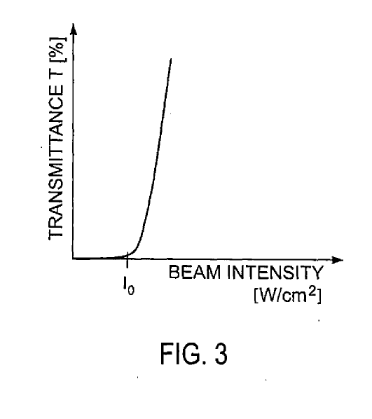

FIG. 3 illustrates an example of optical transmission properties of a saturable absorber gas. In FIG. 3, the horizontal axis shows beam intensity [W/cm²], and the vertical axis shows transmittance T [%]. As shown in FIG. 3, a saturable absorber gas may not transmit a laser beam having beam intensity equal to or lower than predetermined beam intensity I₀ and may transmit only a laser beam having beam intensity higher than the predetermined beam intensity I₀. A saturable absorber gas cell may be a cell in which a saturable absorber gas having the aforementioned optical transmission properties is contained. Such a gas cell may absorb a laser beam having beam intensity equal to or lower than the predetermined beam intensity I₀ and transmit a laser beam having beam intensity higher than the predetermined beam intensity I₀.

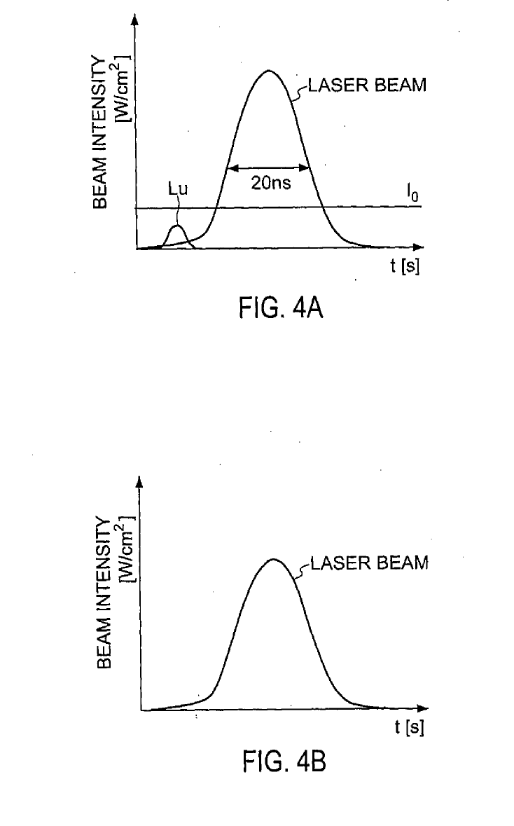

FIG. 4A illustrates an example of beam intensity of a laser beam prior to passing through a saturable absorber gas cell. In FIG. 4A, the horizontal axis shows time [S], and the vertical axis shows beam intensity [W/cm²]. FIG. 4A shows a case where an unwanted ray Lu resulting from a backpropagating beam or self-oscillation is added to the laser beam prior to passing through the saturable absorber gas cell. The saturable absorber gas contained in the saturable absorber gas cell in this case may have the optical transmission properties described above with reference to FIG. 3.

FIG. 4B illustrates an example of beam intensity of a laser beam after passing through a saturable absorber gas. As shown in FIG. 4B, upon passing through the saturable absorber gas cell, the beam intensity of the laser beam may be so changed that the unwanted ray Lu is substantially removed. In this way, the saturable absorber gas cell may absorb to remove a part of the laser beam which has beam intensity equal to or lower than the predetermined beam intensity I₀. Accordingly, a backpropagating beam or unwanted rays resulting from self-oscillation may be suppressed.

However, as the saturable absorber gas absorbs a laser beam, the temperature of the saturable absorber gas may rise. Accordingly, the saturable absorber gas may cease to exhibit the optical transmission properties shown in FIG. 3. Therefore, in the laser apparatus 3 according to one or more embodiments in the present disclosure, a configuration may be provided for suppressing a rise in temperature of the saturable absorber gas and ensuring the saturable absorber gas to function properly for an extended period of time. Details thereof will be described later.

### 2.2 Operation

Referring back to FIG. 2, an operation of the laser apparatus 3 shown in FIG. 2 will now be described.

First, the master oscillator 310 may oscillate at a predetermined repetition rate to output a laser beam in pulses. Further, power may be supplied to the amplifiers 320 from a power supply (not separately shown) while the laser beam passes through the amplifier 320. Power may also be supplied to the amplifiers 320 even while the laser beam is not present in the amplifiers 320 to cause an electric discharge and pump the CO₂ laser gas.

The laser beam from the master oscillator 310 may pass through the first optical isolator 331. The laser beam from the first optical isolator 331 may then enter the first amplifier 321 and be amplified as the laser beam passes through the first amplifier 321.

The amplified laser beam from the first amplifier 321 may then pass through the second optical isolator 332. A backpropagating beam from a target 27 may be attenuated by the second optical isolator 322 and self-oscillation of the first amplifier 321 may be suppressed. Further, the laser beam from the second optical isolator 332 may then enter the second amplifier 322 and be further amplified as the laser beam passes through the second amplifier 322.

Similarly, the laser beam from a (k−1)-th amplifier 32k−1 (not separately shown) may pass through the k-th optical isolator 33k and enter the k-th amplifier 32k. Then, the laser beam may be further amplified as the laser beam passes through the k-th amplifier 32k. By repeating the above-described operation, the laser beam may be gradually amplified. A backpropagating beam from a target 27 may be attenuated by the k-th optical isolator 33k, and self-oscillation of the amplifier 32k−1 may be suppressed.

### 2.3 Effect

By using an optical isolator 330 configured as a saturable absorber gas cell, a part of the laser beam which has beam intensity higher than predetermined peak intensity may be transmitted with high transmittance. Accordingly, weak rays such as amplified spontaneous emission (ASE) light may be substantially absorbed and intense rays such as the laser beam from the master oscillator 310 and the amplified laser beam may be transmitted with high transmittance. Thus, amplification of ASE light generated in an amplifier 320 may be suppressed. Further, a backpropagating beam from a target 27 may be suppressed by the saturable absorber gas cell.

### 3. Slab Saturable Absorber Gas Cell

### 3.1 Configuration

A saturable absorber gas cell configured as the optical isolator 330 will now be described. Hereinafter, since the optical isolator 330 and the saturable absorber gas cell are identical, the same reference numeral “330” will be used to designate an optical isolator and a saturable absorber gas cell.

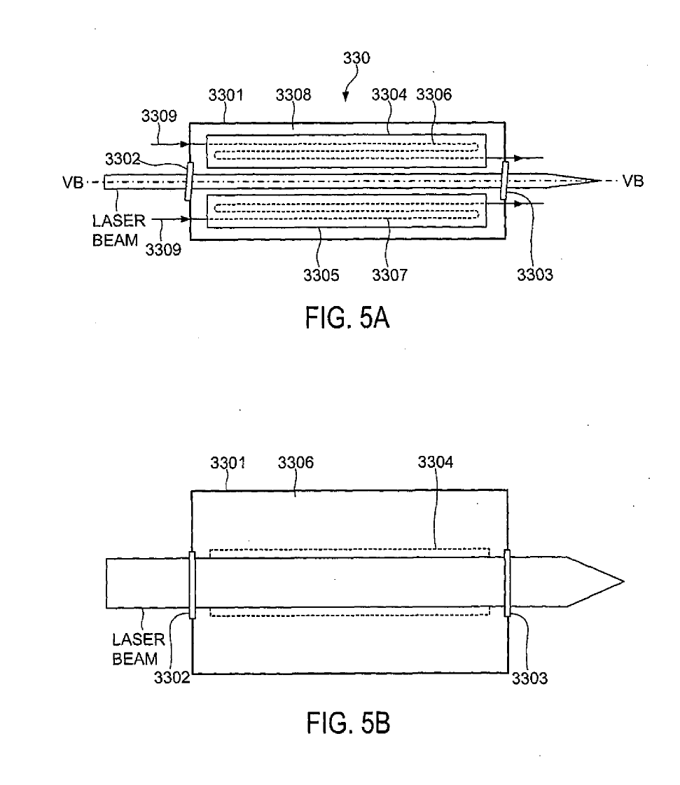

FIG. 5A is a sectional view of a saturable absorber gas cell in a laser apparatus according to one embodiment of the present disclosure. FIG. 5B is a sectional view of the saturable absorber gas cell shown in FIG. 5A, taken along VB-VB plane.

In FIGS. 5A and 5B, the saturable absorber gas cell 330 of the laser apparatus 3 may include a chamber 3301, an input window 3302, an output window 3303, and a pair of cooling plates 3304 and 3305. The cooling plates 3304 and 3305 may not need to be provided in plurality, and at least one of the cooling plates 3304 and 3305 may be provided. Flow channels 3306 and 3307 may be formed inside the cooling plates 3304 and 3305, respectively. Each of the flow channels 3306 and 3307 may be connected to a cooling pipe 3309 provided outside the saturable absorber gas cell 330. Further, the chamber 3301 may be filled with a saturable absorber gas 3308. Although the saturable absorber gas 3308 is not depicted as an entity, it is assumed herein that the chamber 3301 is filled with the saturable absorber gas 3308. This is also applicable to the description to follow.

The input window 3302 and the output window 3303 may be provided on side surfaces of the chamber 3301 such that the laser beam enters the chamber 3301 through the input window 3302 and is outputted therefrom through the output window 3303. The pair of cooling plates 3304 and 3305 may be provided in the chamber 3301 to face each other with the beam path of the laser beam arranged therebetween.

The chamber 3301 may serve as a processing chamber that is filled with the saturable absorber gas 3308 and that houses the cooling plates 3304 and 3305. The shape of the chamber 3301 is not particularly limited, and may be suitably configured depending on the beam profile of the laser beam or on the applications. In one embodiment, the shape of the chamber 3301 may, for example, be a parallelepiped that is shaped like a slab. In the laser apparatus 3 shown in FIGS. 5A and 5B, a sheet laser beam may be used, and the chamber 3301 may be formed into a slab shape. Accordingly, the saturable absorber gas cell 330 shown in FIGS. 5A and 5B may be referred to as the slab saturable absorber gas cell 330 as well.

The input window 3302 and the output window 3303 may be formed of diamond, ZnSe, or GaAs that transmits a CO₂ laser beam with high transmittance. In one embodiment, a diamond window having high thermal conductivity may be used as each of the input window 3302 and the output window 3303.

The cooling plates 3304 and 3305 may be provided inside the chamber 3301 in order to cool the saturable absorber gas 3308. The saturable absorber gas 3308 may absorb a laser beam having beam intensity equal to or lower than predetermined peak intensity, and as a result, the temperature of the saturable absorber gas 3308 may rise. When the temperature of the saturable absorber gas 3308 rises, the wavefront of the laser beam to be outputted from the saturable absorber gas cell 330 may deform. Thus, the cooling plates 3304 and 3305 may cool the saturable absorber gas 3308 in order to suppress the deformation in the wavefront of the laser beam. By providing the cooling plates 3304 and 3305 inside the chamber 3301, the saturable absorber gas 3308 may be cooled directly, and thus, cooling efficiency may be increased.

The cooling plates 3304 and 3305 may be provided along the beam path of the laser beam such that the lengthwise direction of the cooling plates 3304 and 3305 extends substantially parallel to the beam path of the laser beam. This configuration may allow the saturable absorber gas 3308 to be cooled along the entire beam path of the laser beam inside the chamber 3301.

A cooling medium such as cooling water may flow in the cooling pipe 3309 and the flow channels 3306 and 3307 to cool the cooling plates 3304 and 3305.

Each of the flow channels 3306 and 3307 may be shaped to meander along a plane shown in FIG. 5B. However, in FIGS. 5A and 5B, to facilitate representation and understanding, each of the flow channels 3306 and 3307 is depicted to meander along a plane shown in FIG. 5A. The shape of the flow channels 3306 and 3307 is not particularly limited and may be configured suitably in accordance with the applications. This is also applicable to the description to follow.

The cooling plates 3304 and 3305 may be formed of a material having high thermal conductivities, and may, for example, be formed of a metal material such as aluminum or copper.

Although the cooling plates 3304 and 3305 may not need to be provided in plurality, in order to obtain sufficient cooling efficiency, the plurality of cooling plates 3304 and 3305 may preferably be used to cool the saturable absorber gas 3308 around the laser beam. In the slab saturable absorber gas cell 330 shown in FIGS. 5A and 5B, since the sheet laser beam is used, the cooling plates 3304 and 3305 may preferably be provided to cool the saturable absorber gas 3308 from upper and lower sides of the sheet laser beam.

Further, the cooling plates 3304 and 3305 may preferably be provided close to the beam path of the laser beam in order to enhance the cooling efficiency. Thus, the cooling plates 3304 and 3305 may be provided as close as possible to the beam path of the laser beam within a range where the cooling plates 3304 and 3305 are not irradiated with the laser beam.

Since the cooling plates 3304 and 3305 may only need to surround the beam path of the laser beam, the cooling plates 3304 and 3305 may be configured as a single cooling tube shaped as a quadrangular prism with the upper and lower surfaces of the quadrangular prism removed.

Further, even in a case where the laser beam has a circular cross section, the cooling plates 3304 and 3305 shown in FIGS. 5A and 5B may be used as well. For example, if each of the cooling plates 3304 and 3305 is made sufficiently wider than the width of the laser beam, the saturable absorber gas 3308 around the laser beam may be cooled sufficiently.

In a case where the laser beam is circular, each of the cooling plates 3304 and 3305 may be configured into a hemispherical shape or a curved shape, or may be configured as a single cylindrical cooling cylinder.

A type of gas to be used as the saturable absorber gas 3308 is not particularly limited, and various types of gas may be used as long as the given gas has properties where a laser beam having beam intensity equal to or lower than predetermined peak intensity is absorbed and is not transmitted. For example, when a bandwidth of the laser beam is 10.6 μm, gas containing at least one of SF₆, N₂F₄, PF_{S}, BCl₃, CH₃CHF₂, and high-temperature CO₂ may be used. Further, when a bandwidth of the laser beam is 9.6 μm, gas containing at least one of CH₃OH, CH₃F, HCOOH, CD₃OD, CD₃F, and DCOOD, where D is deuterium, may be used. Furthermore, when a bandwidth of the laser beam is 9.6 μm, gas containing C₂F₃Cl may also be used.

Here, gas in the saturable absorber gas cell 330 may include, aside from the aforementioned gases, N₂ or He gas as a buffer gas.

Further, when CO₂ is used as the saturable absorber gas 3308, CO₂ gas at a temperature of approximately 400° C. may, for example, be used.

### 3.2 Operation

First, an assumption is that a laser beam to enter the saturable absorber gas cell 330 is a sheet laser beam generated through any suitable method. For example, the laser beam may be a sheet laser beam outputted from a slab amplifier to be described later. Alternatively, the sheet laser beam may be generated from a circular laser beam using a cylindrical mirror.

As a specific operation, the sheet laser beam may be transmitted through the input window 3302, pass through a space between the pair of cooling plates 3304 and 3305, and be transmitted through the output window 3303.

When the laser beam passes through the saturable absorber gas 3308, a part of the laser beam having beam intensity equal to or lower than predetermined beam intensity may be absorbed by the saturable absorber gas 3308 with high absorptance. Heat generated as the saturable absorber gas 3308 which absorbs a part of the laser beam may be released through the cooling plates 3304 and 3305. Accordingly, even if the saturable absorber gas 3308 continuously absorbs a laser beam, the above-described properties of the saturable absorber gas 3308 may be maintained.

### 3.3 Effect

According to the laser apparatus of this embodiment, heat generated in the saturable absorber gas 3308 may be dissipated through thermal diffusion of the cooling plates 3304 and 3305. As a method for cooling the saturable absorber gas 3308, the saturable absorber gas 3308 may be circulated through a circulation system provided outside the saturable absorber gas cell 330, and the saturable absorber gas 3308 may be cooled with a heat exchanger provided in the circulation system. However, in this method, a circulation system for circulating a saturable absorber gas and/or a heat exchanger are/is required, which increases the apparatus in size and in cost. Further, since the saturable absorber gas is cooled indirectly with the heat exchanger, the cooling efficiency is not necessarily high.

On the other hand, according to the laser apparatus 3 of this embodiment, a circulation system and/or a heat exchanger are/is not necessary. Further, the cooling plates 3304 and 3305 make direct contact with the saturable absorber gas 3308, and thus the cooling efficiency may be improved.

### 3.4 Multipass Saturable Absorber Gas Cell: First Modification

Subsequently, a saturable absorber gas cell that differs from the saturable absorber gas cell 330 will be described as a first modification.

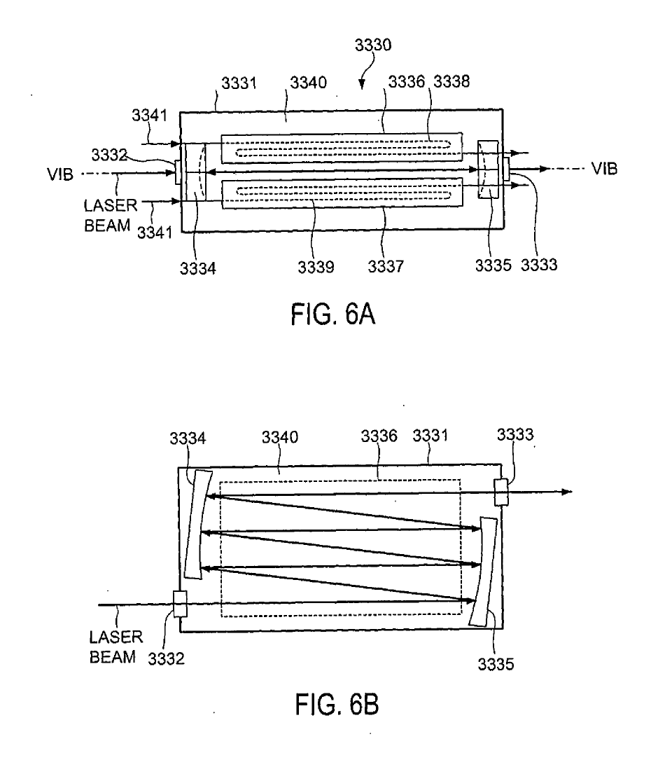

FIG. 6A is a sectional view illustrating an example of a saturable absorber gas cell according to the first modification. FIG. 6B is a sectional view of the saturable absorber gas cell shown in FIG. 6A, taken along VIB-VIB plane.

As shown in FIGS. 6A and 6B, a saturable absorber gas cell 3330 of the first modification may include a chamber 3331, an input window 3332, an output window 3333, concave mirrors 3334 and 3335, a pair of cooling plates 3336 and 3337, flow channels 3338 and 3339, and a saturable absorber gas 3340. The cooling plates 3336 and 3337 may not need to be provided in plurality. At least one of the cooling plates 3336 and 3337 may be provided. Further, a cooling pipe 3341 connected to the flow channels 3338 and 3339 may be provided outside the saturable absorber gas cell 3330.

In the saturable absorber gas cell 3330, the chamber 3331, the input window 3332, and the output window 3333 may have similar configurations and functions to those in the saturable absorber gas cell 330 shown in FIGS. 5A and 5B, and thus detailed description thereof will be omitted.

The saturable absorber gas cell 3330 of the first modification may differ from the saturable absorber gas cell 330 shown in FIGS. 5A and 5B in that the saturable absorber gas cell 3330 includes the concave mirrors 3334 and 3335 inside the chamber 3331. The concave mirror 3334 may be provided at the side of the input window 3332 and the concave mirror 3335 may be provided at the side of the output window 3333. The concave mirrors 3334 and 3335 may be provided so that the reflective surfaces thereof face each other. As shown in FIG. 6B, the laser beam that has entered the saturable absorber gas cell 3330 through the input window 3332 may travel back and forth multiple times between the facing concave mirrors 3334 and 3335 and be outputted through the output window 3333. That is, a multipass may be formed through which the laser beam travels multiple times through the saturable absorber gas 3340. Through the above-described configuration, an optical path length of the laser beam traveling in the saturable absorber gas 3340 may be extended. Thus, even if the concentration of the saturable absorber gas 3340 is kept low, the saturable absorbing properties thereof may be retained. Further, if the concentration of the saturable absorber gas 3340 is decreased, absorption of the laser beam per unit length along the beam path of the laser beam is decreased as well. Accordingly, the rise in temperature of the saturable absorber gas 3340 may be suppressed.

As described above, in the saturable absorber gas cell 3330 of the first modification, an optical system in which the laser beam makes a multipass between the pair of concave mirrors 3334 and 3335 is employed. Thus, a surface of each of the cooling plates 3336 and 3337 may be large enough to cover substantially the entire multipass beam path of the laser beam. As shown in FIG. 6A, the saturable absorber gas cell 3330 may be similar to the saturable absorber gas cell 330 shown in FIGS. 5A and 5B in that the pair of cooling plates 3336 and 3337 is provided to face each other with the beam path of the laser beam sandwiched therebetween. However, as shown in FIG. 6B, the saturable absorber gas cell 3330 may differ from the saturable absorber gas cell 330 in that the cooling plates 3336 and 3337 are wider than the cooling plates 3304 and 3305 to cover substantially the entire multipass beam path of the laser beam. Thus, the saturable absorber gas 3340 may be cooled along substantially the entire multipass beam path of the laser beam.

The laser beam that enters the saturable absorber gas cell 3330 in the first modification does not need to be a sheet laser beam, and may be a circular laser beam having a diameter that is smaller than the distance between the pair of cooling plates 3336 and 3337. Since the cooling plates 3336 and 3337 cover a sufficiently large region with respect to the laser beam, a sufficient cooling effect may be provided to the circular laser beam as well.

Further, the multipass optical system of the first modification may be a conjugate optical system configured to transfer an image of an input laser beam on the output laser beam. This multipass optical system may transfer an image of a laser beam at the input window 3332 on a position of the output window 3333 at a magnification rate of substantially 100%. Thus, compared to a case where the saturable absorber gas cell 3330 does not include a transfer optical system, that is, a case where the multipass is formed with flat mirrors, a change in the position and the direction of the output laser beam at the output window 3333 may be suppressed even if the position or the direction of the input laser beam slightly varies.

Alternatively, the concave mirrors 3334 and 3335 may be provided outside the saturable absorber gas cell 3330. For example, in FIGS. 6A and 6B, the input window 3332 and the output window 3333 may be widened in the widthwise direction of the chamber 3331 to cover the entire width of the multipass, and the concave mirrors 3334 and 3335 may be provided outside the chamber 3331.

A laser apparatus of the first modification may be configured by employing the saturable absorber gas cell 3330 configured as described above as at least one of the optical isolators 332 through 33n provided downstream from the respective amplifiers 320 of the laser apparatus 3 shown in FIG. 2.

According to the saturable absorber gas cell 3330 of the first modification, the optical path length may be extended by forming the multipass beam path of the laser beam inside the saturable absorber gas cell 3330, and the saturable absorber gas 3340 may be cooled efficiently by decreasing the concentration of the saturable absorber gas 3340.

### 3.5 Saturable Absorber Gas Cell System

Subsequently, an example where a laser apparatus is configured to include a saturable absorber gas cell system that includes the saturable absorber gas cell 330 shown in FIGS. 5A and 5B will be described.

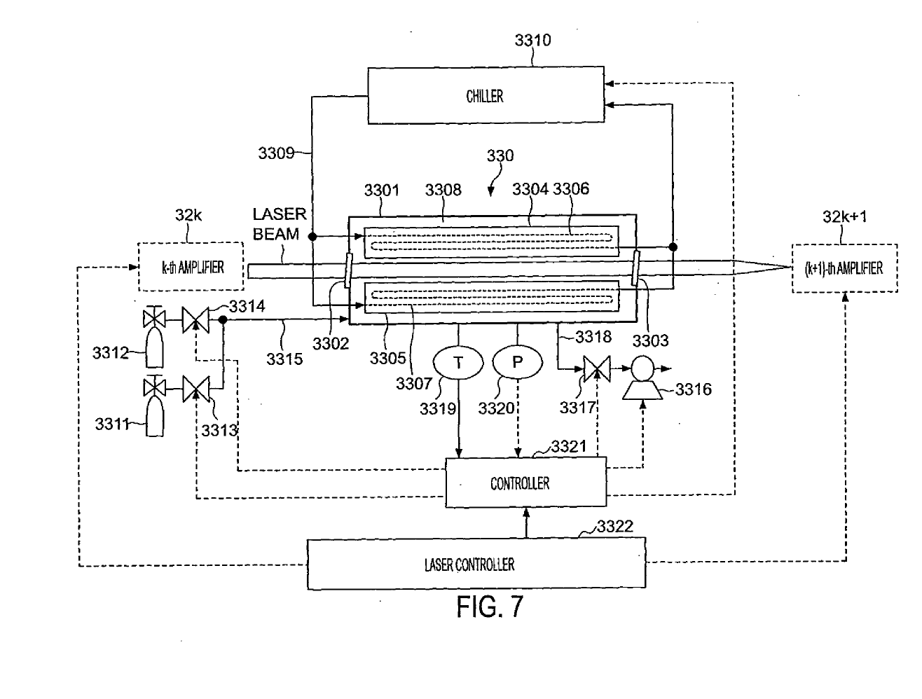

FIG. 7 illustrates an example of a saturable absorber gas cell system in a laser apparatus according to one embodiment of the present disclosure. In the saturable absorber gas cell system shown in FIG. 7, the saturable absorber gas cell 330 shown in FIGS. 5A and 5B is employed, and thus the description of the configuration of the saturable absorber gas cell 330 will be omitted.

The saturable absorber gas cell system shown in FIG. 7 may include, aside from the saturable absorber gas cell 330, a saturable absorber gas tank 3311, a buffer tank 3312, valves 3313 and 3314, a gas supply pipe 3315, an exhaust pump 3316, a valve 3317, a discharge pipe 3318, a temperature sensor 3319, and a pressure sensor 3320. The saturable absorber gas cell system may further include the cooling pipe 3309, a chiller 3310, and a controller 3321. The controller 3321 may be controlled by a laser controller 3322.

The k-th amplifier 32k, the saturable absorber gas cell 330, and a (k+1)-th amplifier 32k+1 may be provided in a beam path of the laser beam. The saturable absorber gas cell 330 may be provided between the k-th amplifier 32k and the (k+1)-th amplifier 32k+1.

The flow channels 3306 and 3307 formed in the cooling plates 3304 and 3305 of the saturable absorber gas cell 330 may be connected to the external cooling pipe 3309, and the cooling pipe 3309 may be connected to the chiller 3310. That is, a cooling medium such as cooling water may be supplied into the flow channels 3306 and 3307 from the chiller 3310 through the cooling pipe 3309.

The saturable absorber gas tank 3311 may be connected to the gas supply pipe 3315 through the valve 3313. The buffer tank 3312 may be connected to the gas supply pipe 3315 through the valve 3314. The gas supply pipe 3315 may be connected to the chamber 3301 so that the saturable absorber gas and the buffer gas can be supplied into the chamber 3301.

The exhaust pump 3316 may be connected to the discharge pipe 3318 through the valve 3317. The discharge pipe 3318 may be connected to the chamber 3301 so that the interior of the chamber 3301 can be exhausted with the exhaust pump 3316.

The temperature sensor 3319 and the pressure sensor 3320 may be connected to the chamber 3301 and also communicably connected to the controller 3321. The controller 3321 may be capable of receiving detection signals from the temperature sensor 3319 and the pressure sensor 3320. The controller 3321 may further be communicably connected to the chiller 3310, the valves 3313, 3314, and 3317. The laser controller 3322 may be communicably connected to the amplifiers 32k and 32k+1 and the controller 3321.

Individual constituent elements of the saturable absorber gas cell system will now be described.

The chiller 3310 may monitor the temperature of the cooling medium supplied to the cooling plates 3304 and 3305. More specifically, the cooling medium supplied from the chiller 3310 may flow through the cooling pipe 3309 into the flow channels 3306 and 3307 in the cooling plates 3304 and 3305 to cool the saturable absorber gas 3308, and return to the chiller 3310 through the cooling pipe 3309. The cooling medium may be cooling water or may be a heat carrier aside from the cooling water.

In one embodiment, when CO₂ gas is used as the saturable absorber gas 3308 and needs to be heated, the following can be carried out. For example, oil may be used as a heat carrier to flow in the cooling plates 3304 and 3305, and the chiller 3310 may be configured to heat or cool the oil. Alternatively, a heating device such as a heater may be provided on each of the cooling plates 3304 and 3305. In this case, the CO₂ gas may be heated or cooled in accordance with the operation state of the laser apparatus 3. More specifically, when the laser apparatus 3 is started or when an output thereof is small, the CO₂ gas may be heated. On the other hand, when an output of the laser apparatus 3 reaches or exceeds a predetermined level, the CO₂ gas needs to be cooled since the temperature may rise excessively by heat generated as the CO₂ gas absorbs the laser beam. Then, the chiller 3310 may cool the cooling medium.

The saturable absorber gas tank 3311 may be a saturable absorber gas supply source. The saturable absorber gas tank 3311 may contain any of the various saturable absorber gases cited above in the description of the saturable absorber gas cell 330 shown in FIGS. 5A and 5B. The valve 3313 may adjust an amount of the saturable absorber gas supplied from the saturable absorber gas tank 3311 into the chamber 3301 in accordance with an instruction from the controller 3321. In the present embodiment, an example where the saturable absorber gas tank 3311 contains SF₆ will be described.

The buffer gas tank 3312 may be a buffer gas supply source. The buffer gas tank 3312 may, for example, contain an inert gas such as N₂ or He. When the concentration of the saturable absorber gas 3308 in the chamber 3301 is excessively high, the absorption of the laser beam becomes excessively high. In that case, the buffer gas may be supplied to adjust the concentration of the saturable absorber gas 3308 in the chamber 3301. A supply amount of the buffer gas may be controlled by adjusting the opening of the valve 3314 in accordance with an instruction from the controller 3321. In the present embodiment, an example where N₂ gas is used as the buffer gas will be described.

The exhaust pump 3316 may discharge gas inside the chamber 3301 through the discharge pipe 3318. A discharge amount by the exhaust pump 3316 may be controlled by adjusting the opening of the valve 3317 in accordance with an instruction from the controller 3321.

The temperature sensor 3319 may detect a temperature inside the chamber 3301. The pressure sensor 3320 may detect a pressure inside the chamber 3301. Sensing stations of the temperature sensor 3319 and the pressure sensor 3320, respectively, may, for example, be provided inside the chamber 3301, and a detection result of each of the temperature sensor 3319 and the pressure sensor 3320 may be outputted to the controller 3321. The controller 3321 may in turn carry out various controls in accordance with received detection results.

The controller 3321 may control the chiller 3310 and the valves 3313, 3314, and 3317 based on a detected temperature and a detected pressure inside the chamber 3301. Thus, a temperature and a flow rate of a cooling medium circulating in the flow channels 3306 and 3307, a supply amount of the saturable absorber gas and the buffer gas, and a discharge amount of gas from the chamber 3301 may be controlled, and the saturable absorber gas cell system may be driven in an optimal state. Here, for carrying out the control operations described above, the controller 3321 may include a central processing unit (CPU), a microcomputer that operates by loading a program, and an application specific integrated circuit (ASIC).

Here, when CO₂ is used as the saturable absorber gas 3308, the controller may, for example, control the temperature of the CO₂ gas to be approximately 400° C. In this case, the temperature of the CO₂ gas may be controlled to be a predetermined temperature of approximately 400° C. based on a detection result of the temperature sensor 3319.

The laser controller 3322 may control the amplifiers 32k and 32k+1 and the saturable absorber gas cell 330. The laser controller 3322 may send an instruction to the controller 3321 to control the saturable absorber gas cell 330.

An operation of the saturable absorber gas cell system having the above-described configuration will now be described.

The controller 3321 may first drive the exhaust pump 3316 and open the valve 3317 to discharge gas from the chamber 3301. Then, when a pressure measured by the pressure sensor 3320 falls to or below a predetermined value and the chamber 3301 reaches a near vacuum state, the controller 3321 may close the valve 3317.

Subsequently, the controller 3321 may open the valves 3313 and 3314 to introduce SF₆ gas and N₂ gas into the chamber 3301. Then, when a value detected by the pressure sensor 3320 reaches a predetermined value such as a predetermined partial pressure of the SF₆ gas, the controller 3321 may close the valves 3313 and 3314.

Thereafter, the controller 3321 may send a signal to the chiller 3310 to allow the cooling medium to circulate. The controller 3321 may control a temperature of the cooling medium using the chiller 3310 so that a value to be detected by the temperature sensor reaches a predetermined value.

The controller 3321 may send a signal to the laser controller 3322 to inform that the saturable absorber gas cell 330 has been started.

Thereafter, upon receiving a signal from the controller 3321, the laser controller 3322 may drive the master oscillator 310 and the amplifiers 321 through 32n shown in FIG. 2.

During this time, the controller 3321 may keep monitoring the pressure and the temperature inside the chamber 3301. When the pressure and the temperature fall out of predetermined ranges, respectively, the controller 3321 may send an error signal to the laser controller 3322. When the laser controller 3322 receives an error signal, the laser controller 3322 may cause the laser apparatus 3 to stop outputting a laser beam.

When the pressure and the temperature inside the chamber 3301 fall within predetermined ranges, respectively, the operation may be continued, and the controller 3321 may keep monitoring the pressure and the temperature inside the chamber 3301.

As described above, according to the laser apparatus that includes the saturable absorber gas cell system shown in FIG. 7, the temperature and the pressure inside the saturable absorber gas cell 330 may be monitored, and when an error occurs, an output of a laser beam is stopped. Accordingly, the laser apparatus may be operated with high reliability.

Further, although an example where the saturable absorber gas cell 330 shown in FIGS. 5A and 5B is used is described with reference to FIG. 7, this disclosure is not limited thereto, and a laser apparatus may be configured to include the saturable absorber gas cell 3310 of the first modification described above.

4. Combining with Slab Amplifier

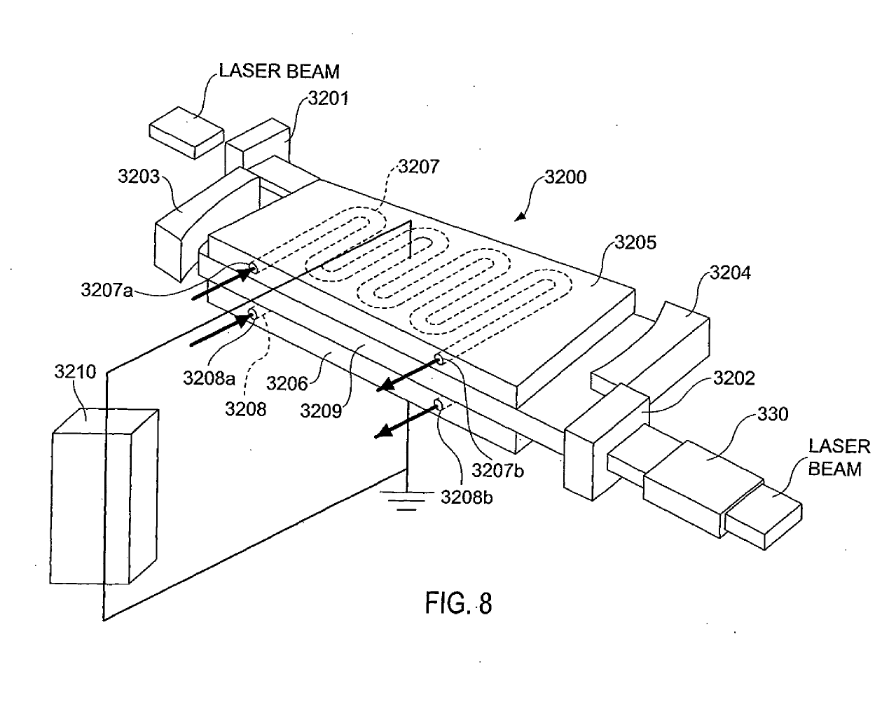

FIG. 8 illustrates an example of a slab amplifier in a laser apparatus according to one embodiment of the present disclosure. Hereinafter, an example where an amplifier 320 is configured as a slab amplifier 3200 and where the slab saturable absorber gas cell 330 shown in FIGS. 5A and 5B is provided downstream from the slab amplifier 3200 will be described.

The slab amplifier 3200 may include an input window 3201, an output window 3202, a pair of high-reflection concave mirrors 3203 and 3204, a pair of electrodes 3205 and 3206, and a radio frequency (RF) power supply 3210. Flow channels 3207 and 3208 may be formed inside the respective electrodes 3205 and 3206, and the flow channels 3207 and 3208 may include inlets 3207a and 3208a and outlets 3207b and 3208b, respectively. Further, a space to serve as a discharge region 3209 may be secured between the electrodes 3205 and 3206. Here, a laser chamber (not separately shown) may be provided to house the electrodes 3205 and 3206.

The high-reflection concave mirrors 3203 and 3204 may be provided to face each other with the discharge region 3209 located therebetween. A laser beam reflected by the high-reflection concave mirrors 3203 and 3204 may make a multipass within the discharge region 3209 secured between the electrodes 3205 and 3206.

The electrode 3205 and the electrode 3206 may be provided to face each other, and the discharge region 3209 secured therebetween may be filled with a gaseous gain medium. A CO₂ laser gas may, for example, be used as the gain medium. A cooling medium such as cooling water may flow into the flow channels 3207 and 3208 formed inside the electrodes 3205 and 3206 through the inlets 3207a and 3208a and flow out through the outlets 3207b and 3208b. The RF power supply 3210 may be connected to the electrodes 3205 and 3206 to apply a high frequency voltage therebetween. Here, the electrode 3205 may be connected to a high potential side of the RF power supply 3210, and the electrode 3206 may be connected to a low potential side of the RF power supply 3210 and may also be grounded.

In the slab amplifier 3200 configured as described above, a laser beam may enter the aforementioned laser gas chamber (not separately shown) filled with a gain medium such as a CO₂ laser gas through the input window 3201. Then, a high frequency voltage may be applied between the flat electrodes 3205 and 3206, and thus a discharge may occur in the discharge region 3209. As the laser beam is reflected by the pair of high-reflection concave mirrors 3203 and 3204 to form a multipass in the discharge region 3209, the laser beam may be amplified, and the amplified laser beam may be outputted from the laser gas chamber through the output window 3202.

Here, an optical system forming a multipass in the discharge region 3209 may be a conjugate optical system in which an image of the input laser beam is transferred onto the output laser beam.

Further, the laser beam in this example may be a sheet laser beam elongated in a direction perpendicular to the discharge direction in the discharge region 3209.

As described above, the slab saturable absorber gas cell 330 may be provided to serve as an optical isolator in a beam path downstream from the slab amplifier 3200.

Here, although an example where the saturable absorber gas cell 330 shown in FIGS. 5A and 5B is provided downstream from the slab amplifier 3200 is described with reference to FIG. 8, the present disclosure is not limited thereto, and the saturable absorber gas cell 3330 of the first modification may be provided downstream from the slab amplifier 3200 as well.

### 5. External Cooling System Saturable Absorber Gas Cell

### 5.1 Plate Type External Cooling System Saturable Absorber Gas Cell: Second Modification

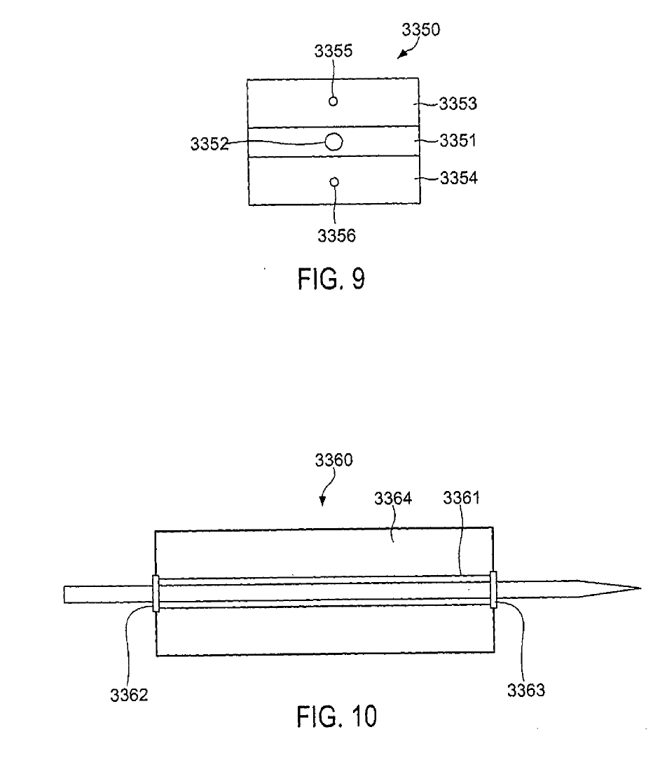

FIG. 9 illustrates an example of a saturable absorber gas cell according to a second modification. In FIG. 9, a saturable absorber gas cell 3350 of the second modification may include a chamber 3351 and cooling plates 3353 and 3354 provided to sandwich the chamber 3351. In FIG. 9, an input window 3352 of the chamber 3351 and inlets of flow channels 3355 and 3356 in the electrodes 3353 and 3354 are also shown.

As stated above, the cooling plates 3353 and 3354 may be provided to cover the upper and lower surfaces of the chamber 3351, and the saturable absorber gas inside the chamber 3351 may be cooled from the outside of the chamber 3351.

The configuration of the interior of the chamber 3351 may be such that the cooling plates 3304 and 3305 in the chamber 3301 of the saturable absorber gas cell 330 shown in FIGS. 5A and 5B are removed. Further, as shown in FIG. 9, the thickness of the chamber 3351 may be reduced, and may cause the cooling efficiency of the saturable absorber gas thereinside to be increased. In this case, the chamber 3351 may be formed of a highly thermally conductive material such as metal.

Further, the configuration of individual constituent elements of the saturable absorber gas cell 3350 such as the chamber 3351 and the cooling plates 3353 and 3354 may be substantially the same as those of the saturable absorber gas cell 330 shown in FIGS. 5A and 5B, and thus the description thereof will be omitted.

Although an example where the cooling plates 3353 and 3354 are used as a cooling unit to partially cover the chamber 3351 is described with reference to FIG. 9, the present disclosure is not limited thereto, and a type of a cooling unit is not particularly limited as long as the cooling unit can directly cover the outer surface of the chamber 3351.

The saturable absorber gas cell 3350 of the second modification may be combined with the multipass saturable absorber gas cell 3300 of the first modification shown in FIGS. 6A and 6B. Further, the saturable absorber gas cell 330 shown in FIGS. 7 and 8 may be replaced by the saturable absorber gas cell 3350.

### 5.2 Jacket Type External Cooling System Saturable Absorber Gas Cell: Third Modification

FIG. 10 illustrates an example of a saturable absorber gas cell according to a third modification. In FIG. 10, a saturable absorber gas cell 3360 of the third modification may include a chamber 3361, an input window 3362, an output window 3363, and a cooling jacket 3364.

The saturable absorber gas cell 3360 may differ from the saturable absorber gas cell 3350 in that the saturable absorber gas inside the chamber 3361 is cooled by using the single-piece cooling jacket 3364 configured to cover substantially the entire side surfaces of the chamber 3361.

In this way, instead of covering a part of the chamber 3361 with the cooling plates, the entire side surfaces of the chamber 3361 may be covered by the cooling jacket 3364. With this configuration, the cooling efficiency may be increased.

The saturable absorber gas cell according to any one of the present embodiments and the first through third modifications described above may be provided at downstream side inside the laser apparatus, but may also be provided at an upstream side inside the laser apparatus. Thus, the saturable absorber gas cell described above may be used as the first optical isolator 331 (see FIG. 2) immediately downstream from the master oscillator 310 or as any one of the other optical isolators 332 through 33n.

The above-described examples and the modifications thereof are merely examples for implementing the present disclosure, and the present disclosure is not limited thereto. Making various modifications according to the specifications or the like is within the scope of the present disclosure, and other various examples are possible within the scope of the present disclosure. For example, the modifications illustrated for particular ones of the examples can be applied to other examples as well (including the other examples described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A laser apparatus, comprising:
a master oscillator configured to output a laser beam;
at least one amplifier provided in a beam path of the laser beam;
at least one saturable absorber gas cell provided downstream from the at least one amplifier and configured to contain a saturable absorber gas for absorbing a part of the laser beam, the part having a beam intensity equal to or lower than a predetermined beam intensity; and
a cooling unit for cooling the saturable absorber gas.

2. The laser apparatus according to claim 1, wherein the cooling unit is provided inside the saturable absorber gas cell.

3. The laser apparatus according to claim 2, wherein the cooling unit includes at least one cooling plate having a flow channel formed thereinside.

4. The laser apparatus according to claim 3, wherein the at least one cooling plate includes a pair of cooling plates provided to sandwich the beam path of the laser beam.

5. The laser apparatus according to claim 1, wherein the cooling unit includes a cooling plate having a flow channel formed thereinside and configured to cover at least a part of an outer surface of the saturable absorber gas cell.

6. The laser apparatus according to claim 1, wherein the cooling unit includes a cooling jacket provided to cover substantially the entire outer surface of the saturable absorber gas cell.

7. The laser apparatus according to claim 1, wherein the saturable absorber gas cell is provided downstream from the master oscillator in the beam path of the laser beam.

8. The laser apparatus according to claim 1, further comprising a Pockels cell provided downstream from the master oscillator to function as an optical isolator, the Pockels cell being configured of electrodes sandwiching an electro-optical crystal formed of CdTe.

9. The laser apparatus according to claim 1, wherein the saturable absorber gas cell contains at least one of SF₆, N₂F₄, PF_{S}, BCl₃, CH₃CHF₂, CO₂, CH₃OH, CH₃F, HCOOH, CD₃OD, CD₃F, DCOOD, and C₂F₃Cl.
